(19) United States
(12) Patent Application Publication
(10) Pub. No.: US 2007/0260724 A1
(43) Pub. Date: Nov. 8, 2007

(54) Networking architecture

(76) Inventor: Sandy Rowley, Reno, NV (US)

Correspondence Address: HAVERSTOCK & OWENS LLP, 162 N WOLFE ROAD, SUNNYVALE, CA, 94086, US

(21) Appl. No.: 11/787,828

(22) Filed: Apr. 17, 2007

Related U.S. Application Data
(60) Provisional application No. 60/792,789, filed on Apr. 17, 2006.
(60) Provisional application No. 60/847,984, filed on Sep. 27, 2006.

(51) Int. Cl. G06F 15/173

(52) U.S. Cl. 709/223

(57) ABSTRACT

An architecture and system for speed networking is disclosed. In accordance with the embodiments of the invention a computer-based system is configured to generate and store user profiles that contain user interests and goals. The system matches user profiles to define a group of users with the same or similar interests or goals and initiates one-on-one online chat sessions between pairs of users within the group. The one-on-one online chat sessions preferably last for a selected or predetermined period of time. Users then rank or rate the one-on-one online chat sessions according to a satisfaction factor. The system automatically catalogs contact information between the users that had satisfaction factors within personal contact libraries that can be accessed or modified by the users at a later date.

### RELATED APPLICATIONS

This Application claims priority under 35 U.S.C. § 119(e) from the Co-pending U.S. Provisional Patent Application Ser. No. 60/729,789, filed on Apr. 17, 2006, and titled “SPEED NETWORKING ARCHITECTURE” and the Co-pending U.S. Provisional Patent Application Ser. No. 60/847,984, filed on Sep. 27, 2006, and titled “SPEED NETWORKING ARCHITECTURE,” both of which are hereby incorporated by reference.

### FIELD OF THE INVENTION

The present invention relates to architectures and systems for linking, matching or otherwise networking people, groups and/or businesses together. More specifically, this invention relates to architectures and systems for linking, matching or otherwise networking persons, groups and/or business with a common goal or interest over a network.

### BACKGROUND OF THE INVENTION

Before the Internet became popular, a lot of people were already online through the use of bulletin boards and online services. A bulletin board is comparable to a single, isolated Web site that you reach using special communications software and a modem. You create an entry in the software for the bulletin board that contains the board's direct phone number and any special parameters for connecting to the computer hosting the bulletin board. Once connected to the board, you normally use a series of menus to navigate through the board's contents. To reach another board, you have to disconnect from the first board and dial up to the other one. Major online services, such as America Online (AOL), Prodigy and CompuServe, were the main service that ordinary people use to connect to and communicate with each other online.

In the early 1990s, as people began to spend increasing amounts of time on the Internet, creative software developers designed software that could reproduce some of the aspects of an online service. Chat-room software was developed and set up on Web servers, used by sites, such as TalkCity. Instant messaging really exploded on the Internet scene in November 1996.

There is no doubt that the Internet has changed the way we communicate. For many of us, e-mail has virtually replaced traditional letters and even telephone calls as the choice for correspondence. Every day, billions of e-mail messages are sent out. E-mail has been the most rapidly adopted form of communication ever known.

Instant messaging allows a user to maintain a list of people that you wish to interact with. You can send messages to any of the people in your list, often called a buddy list or contact list, as long as that person is online. Sending a message opens up a small window in which the user and the others on the list can type in messages that all who are on the list and on-line can see.

In our fast-paced world, sometimes even the rapid response of e-mail is not fast enough. You have no way of knowing if the person you are sending an e-mail to is online at that particular moment or not. Also, if you are sending multiple e-mails back and forth with the same person, you normally have to click through a few steps to read, reply and send the e-mail. Instant messaging and chat rooms, while providing a solution to some of the shortcomings, still do not provide the ability to surf the Web or a group of users and quickly discern a person, business, group of people or other entity which has a common interest.

Accordingly there is continued need to develop architectures, systems for and method of linking, matching or otherwise networking people, groups and/or businesses with a common goal or interest together.

### SUMMARY OF THE INVENTION

The present invention is directed to a Speed Networking Architecture (SNA). In accordance with the embodiments of the invention the SNA is a pay-for-use service, wherein business cards or other data are stored in an electronic library at a host web server.

In operation, a user logs into his or her account and is able to search for or “join” in with other users, herein referred to as contacts, that are also logged into the system and that have data that matches one or more of the categories corresponding to the user or the user's interests. Alternatively, the user can select one or more categories and join into or initiate a “chat room” or “chat session,” referred to herein as “interactive communication,” that matches the one or more chat categories or subjects that are selected by the user. As described above, the chat session can be text and/or video streaming, wherein users can see each other in real time during the chat session.

The chat categories can be matched directly with information from the user's business card or other data including data within the user's profile. Alternatively, the categories can be matched indirectly using any simple or complicated algorithm. Regardless of how the interactive communication is initiated and/or how the user is matched with a contact or contacts, the user engages in “live” or “real time” interactive communication for a selected or predetermined period of time. When the time has expired, the user evaluates, ranks, prioritizes or otherwise judges the contact. If the contact has been deemed to be beneficial to the user, then the user and the contact exchange contact information, which can be electronically stored to generate contact lists or libraries that can be accessed at a later date. The contact information can be in the form of an electronic business card. If the chat session was deemed beneficial by the user, the contact or both, coupons, product information and any other data can be also exchanged between them. In this way, users can rapidly generate contact libraries or lists. The libraries or lists can be prioritized, cropped or organized based on further criteria, such as occupation, to generate a specialty list. The speciality list can be used to send out target product information or other information of probable interest to contacts within the specialty list.

It will be clear to one skilled in art that an electronic contact library or list can also have any simple or complex database structure, whereby the user can sort his or her contact library or list based on information, such as categories used to initiate the chat session, frequencies of chat sessions with a contact, ranking, or any other criteria.

The method can be used for developing business networks, dating networks, and/or special interest networks. The information can then be used to identify a target audience or group of people with advertising, event schedules, products or other information that has a high probability of being of interest to the target audience. The system can be video streamed or text messaging or a combination thereof. Preferably, the chat sessions are live and online over the internet.

In accordance with an embodiment of the invention, the Speed Networking Architecture is operated over a network and uses video streaming, herein referred to Video Speed Networking (VSN). In accordance with this embodiment, the network can be configured to support Dating Services, Speed Networking, Online games and the like. The network can also be used to host events, such as debates, family reunions and conventions. As described above, a user or member creates an account that can include a profile or list of preferences that are used to generate a “wish list” that provides the system with a set of criteria to match the user with other users or members. The system can uniquely match the user or member with other users or members based on the “wish list,” or the system can choose a “wild card contact” to match the user or member with other users or members randomly and, thereby, provide an element of surprise or drama to a meeting and networking process.

In accordance with the Video Speed Networking method of the present invention, a user is matched with a predetermined or selected number of other users for a predetermined or selected duration of time either based on a criteria or randomly, such as described above. After a meeting is initiated, a window pops up on the user's computer screen with a video of a matched user or member that is logged into the system. Both the user and the matched user can be simultaneously displayed side-by-side on the others computer screen. In fact any number of users or members that are participating in a meeting can be displayed the user's or member's computer screens.

Other users can also log into the system and view meetings between users or members either during the meeting or after the meeting has occurred. After users or members view a meeting between other users or members, they can rate the viewed meeting as, for example, a success or a failure. Meetings between users or members are preferably archived and cataloged according meeting data and/or ratings provided by the participants and/or viewers. For example, the meetings can be archived and cataloged according to dates that the meetings occurred, the number of times the meeting has been viewed by other members, ratings of the meetings, comments provided by viewers of the meeting and/or its participants.

After a meeting is completed, the system preferably automatically switches the video stream to another user or set of users which are also logged into the system. The process is then repeated any number of times. The data stored from each of the meetings can be used to construct a contact list, such as described above. Video meetings can also be shared anywhere online via embedding and/or linking. The video meetings can also be used as marketing tools that are sold to marketing professionals, which can use them for directing products and advertising to target audiences.

### BRIEF DESCRIPTION OF THE DRAWINGS

FIGS. 1A-B are block flow diagrams outlining steps for using the Speed Networking Architecture, in accordance with the embodiments of the present invention.

FIG. 2 illustrates a networked system, in accordance with the embodiments of the invention.

FIGS. 3A-B are block flow diagrams outlining steps for filtering contacts, in accordance with the embodiments invention.

### DETAILED DESCRIPTION OF THE INVENTION

The current invention provides an architecture to distribute data between users with a common interest or goal and rapidly build or store libraries of contacts. Users can access their account on the system server by a log-in process, whereby users provide a unique user identification to identify themselves as authorized users of the system. Once logged into their accounts, users can preferably modify their user profiles, access their libraries of contacts, and preferably view their account information.

Preferably, the server supports a graphical user interface which allows users to point-and-click on program selections from within their account. The users can select a topic to initiate one-on-one chat session with other users logged into the system that have selected the same or a similar topic. Alternatively, the system can have any simple or complex mechanism or algorithm to aromatically match, identify or determine users with common interests or goals based on the user profiles and automatically initiate one-on-one chat sessions between those matched or identified users that are logged into the system.

Each of the one-on-one chat sessions is preferably run for a selected or predetermined period of time at the end of which the users are automatically “handed off” to other users within the group that have also been matched, identified or determined to have the same or similar interest or goal. Preferably, the one-on-one chat sessions are conducted using live video streaming between the users from personal computers, such that the one-on-one chat sessions simulate face-to-face meetings.

At the end of each on-on-one chat session users rank each other for compatibility. If one or both of the users indicate that they were compatible, then the system preferably automatically exchanges information between the users and stores the information in their respective contact library where the information can be accessed at a later date, either at their personal computers or at the server. For example, where the users indicated that they were compatible based on the one-on-one chat session, the system automatically exchanges contact information, an electronic business card, product information, a coupon, other business information or any combination thereof. In this way users can quickly build up databases or libraries of useful contacts that have similar or shared interests or goals. Where the one-on-one chat session is a successive one-on-one chat session between the same set of users and the repeated outcome or ranking indicates that the users are now incompatible, the system can be configured to automatically remove relevant contact information, an electronic business card, product information, a coupon, other business information or any combination thereof from the users' respective libraries.

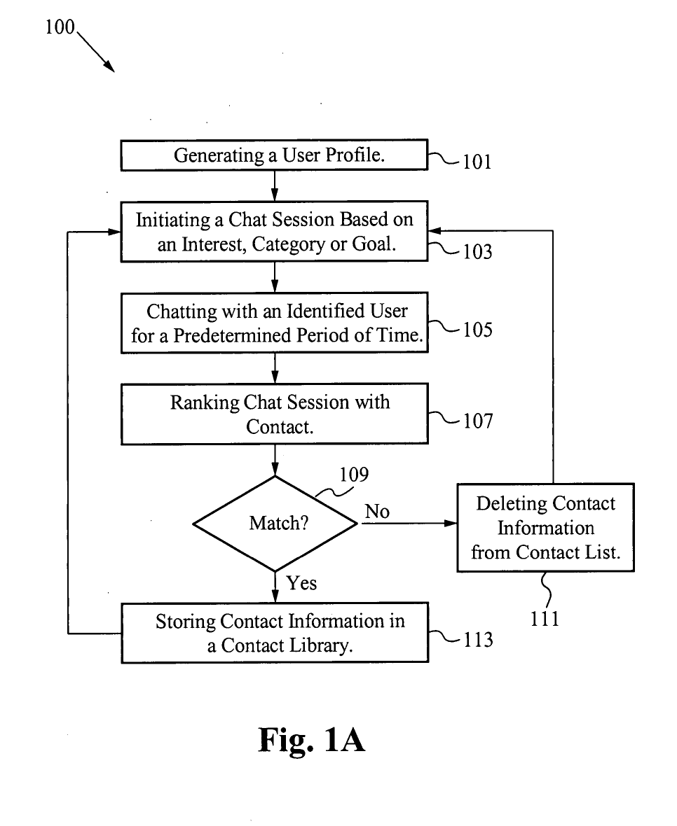

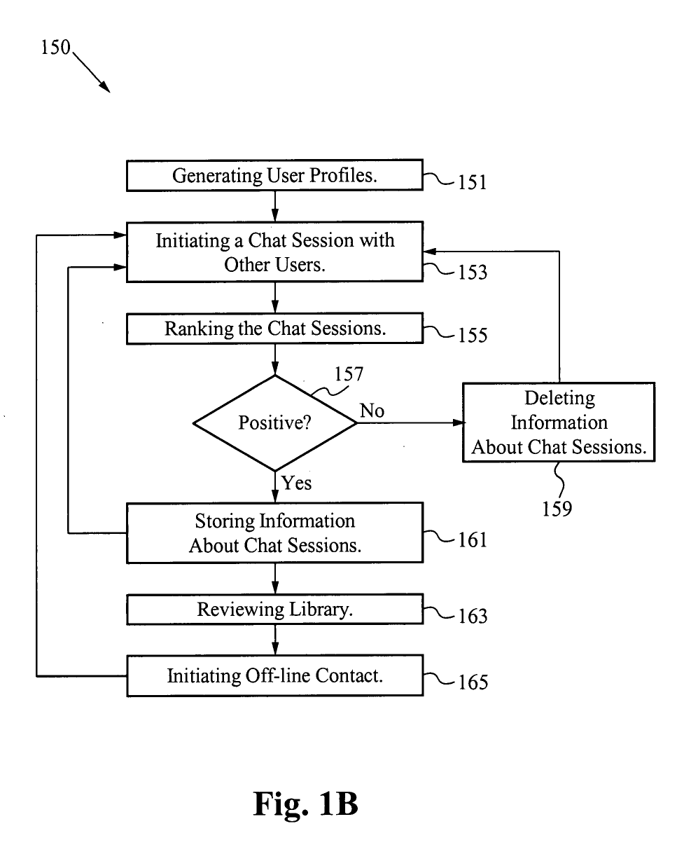

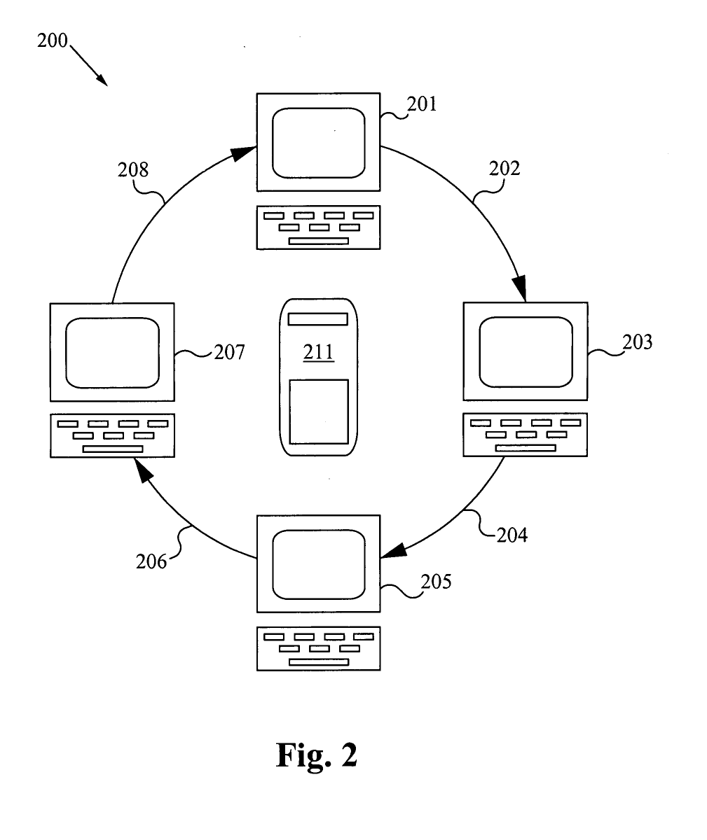

Referring now to FIG. 1A and FIG. 2, a block-flow diagram 100 outlines steps for generating contact libraries or contact lists using the SNA of the present invention. In the step 101 a user generates a user profile. The user profile can include any information or data that can be used to identify another user that has similar interests or goals. For example, the user profile can include person information, hobbies, business interests, subjects or other categories that are used to search for relevant contacts.

The user can generate the user profile in the step 101 either using software on a personal computer or applications software on a server unit 211 (FIG. 2). Either way the server unit 211 preferably uses information in the user profile to initiate a chat session with other identified users in the step 103 that are also logged into the server unit 211 and that have information that matches the information in the profile. The contact can be automatically identified by the system based on matched information in the user profiles alone or in combination with other search terms selected by either of the users.

Still referring to FIG. 1A, after the chat session has been initiated in the step 103, in the step 105 the users communicate or chat for a selected or predetermined period of time using voice, text messaging, video streaming or any combination thereof. The selected or predetermined period of time can be set by the server or selected by the users. Also, the system can be configured to allow the users to extend the time if necessary when one of the users or both of the users determine that additional time is necessary to properly evaluate their compatibility with each other. Preferably the chat sessions last for 15 minutes or less.

Regardless of how the length of time is determined, after the selected or predetermined period of time has lapsed in the step 105, in the step 107 the chat session is ranked or rated. Preferably, the chat session is ranked or rated in the step 107 by the users. However, it will be clear to one skilled in the art that the system can be configured to automatically rank or rate the chat session based on the any formula or algorithm, including the type of information exchanged between the user in the step 105 or the extra time requested by the user to chat. If it is determined in the step 109 that the chat session was useful or beneficial to the users (they matched), in the step 113 contact information is exchanged between the users and stored in their respective contact libraries or contact lists. As described above these contact libraries or contact lists can be accessed at a later date either by the users or by the system initiate further chat sessions.

Still referring to FIG. 1A, when it is determined in the steps 109 that the users are incompatible (i.e., there is no match), the step 111 system can remove or delete and previously existing information regrading regarding each of the users for the others contact library or contact list. After the step 111, steps 103, 105, 107 and 109 are then repeated any number of times with other paired or matched users.

Preferably, the system is configured to automatically initiate a new chat session after the predetermined period of time has elapsed in the step 105. Accordingly, the user can generate a large number of contacts in his or her contact library or list in a relatively short time. Each time the system generates a new chat session in the step 103, the system can be configured to refine the criteria, categories and/or terms that it uses to select contacts based on successes and failures of chat sessions with previously identified contacts or by modifying criteria, categories and/or terms used to identify them.

Now referring to FIG. 1B and FIG. 2. A block-flow diagram 150 outlines steps for generating contact libraries or contact lists using the SNA in accordance with further embodiments of the present invention. In the step 151 the system generates a user profile. The user profile can include any information or data that can be used to identify another user that has similar interests or goals, such as described above. For example, the user profile can include personal information, hobbies, business interests, subjects or other categories that are used to search for relevant contacts.

In the step 153, the server unit 211 uses information from the user profiles to identify a group of matched users logged into the server 211 through remote personal computers 201, 203, 205 and 207. The group of matched users are identified by the system through the user profiles, wherein matched users have similar interests, goals and/or terms listed in their respective user profiles, as described above.

In the step 153, the system initiates one-on-one online chat sessions between the matched users within the group. The one-on-one online chat sessions between the matched users within the group are preferably carried out using live video streaming. The one-on-one online chat sessions preferably last for a fixed, set or predetermined period, such as 15 minutes or less. At the end of the one-on-one online chat sessions between the matched users, in the step 155 the matched users rank their respective one-on-one online chat session with a satisfaction factor. If in the step 157 it is determined that a one-on-one online chat session has a satisfaction factor that is above a threshold value (i.e. is positive), then in the step 161 system automatically catalogs, exchanges and/or stores information in the libraries of a sub-group of matched users that had the positive one-on-one online chat sessions. The information can be in the form of an electronic business card, product information or any other type of information. After the information is exchanged in the step 161, users are “handed-off” as indicated by the arrows 202, 204, 206 and 208 such that new pairs of matched users engage in one-on-one online chat sessions and the steps 153, 155, 157 and 161 are repeated any number of times.

If in the step 157 it is determined that a one-on-one online chat session has a satisfaction factor that is below a threshold value (i.e. was negative), then in the step 159 that system can delete or remove information from the libraries of the matched users that had negative one-on-one online chat sessions and steps 153, 155, 157 and 161 can be repeated any number of times.

Still referring to FIG. 1B, after the steps 153, 155, 157 and 161 have been repeated any number of times, in the step 163 a user can review his or her contact library and/or modify information therein. After reviewing his or her contact library in the step 163, in the step 165 the user can initiate any form of off-line contact or return to the system to have subsequent chat sessions with users or groups of users that are selected from his or her library.

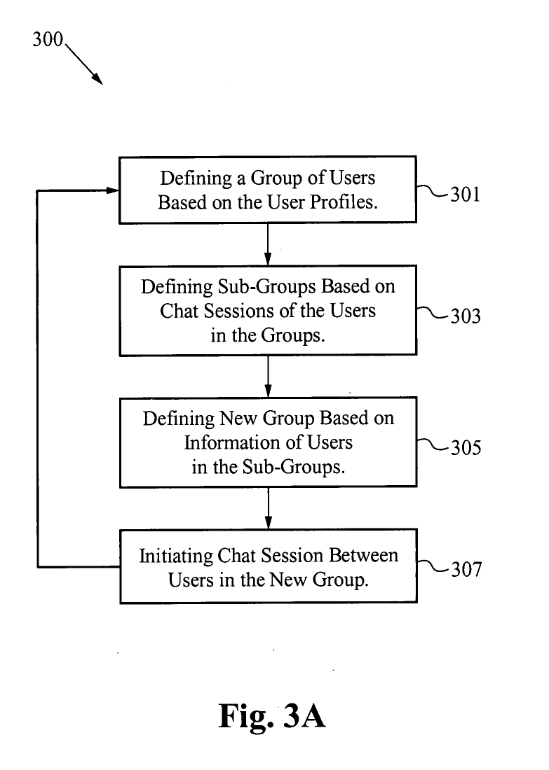

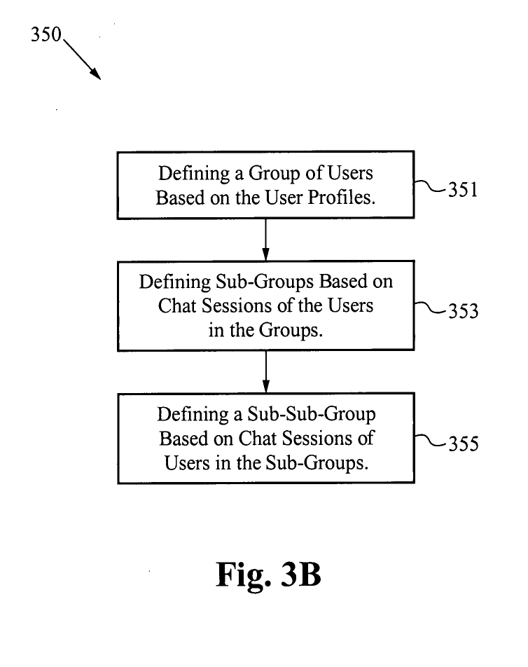

FIG. 3A shows a block-flow diagram 300 for refining or filtering contacts that are used to construct contact libraries, in accordance with the embodiments of the present invention. In the step 301 a group of users is defined based on user profiles, such as described in detail above. In the step 303 a sub-group is defined based on ratings of live one-on-one chat sessions. After a sub-group is defined in the step 303, in the step 305 a new group of users is defined based on selected information of users in the sub-group. For example, the parameters used to match the user profiles can be modified to be more restrictive or require additional matched terms. After the new group has been defined in the step 305, then in the step 307 the new group of user can engage in live one-on-one chat sessions. After the step 307 those users that had one-on-one chat sessions with positive outcomes can exchange information. Alternatively, the steps 301, 303, 305 and 307 can be repeated any number of times to continue to refine contacts prior to exchanging contact information to construct contact libraries or contact lists.

FIG. 3B shows a block-flow diagram 350 for refining or filtering contacts that are used to make contact libraries, in accordance with the embodiments of the present invention. In the step 351 a group of users is defined based on user profiles, such as described in detail above. In the step 353 a sub-group is defined based on ratings of live one-on-one chat session between users of the group. After the sub-group is defined in the step 353, in the step 355 a sub-sub group of users is defined based on ratings of live one-on-one chat session between users in the sub-group. The process can be continued, whereby successive ratings of live one-on-one chat sessions between users are used to filter or select those users prior to exchanging information to construct contact libraries or contact lists.

It will be clear to one skilled in the art that users, groups of users, sub-groups of users whose information is used to construct libraries or contact lists can be selected or filtered in any number of ways. For example, users, groups of users, sub-groups of users or combinations thereof are selected to participate in chat sessions using a neural network architecture that dynamically links users, groups of users, sub-groups or combinations thereof based on modified or changing user profiles.

The system of the present invention can target audiences with products, advertisements or industry information. The system can also host contests or games or have other incentives to get users to participate. Further, the system can host web pages for selected groups that includes links to other selected web sites.

The present invention has been described in terms of specific embodiments incorporating details to facilitate the understanding of the principles of construction and operation of the invention. As such, references herein to specific embodiments and details thereof are not intended to limit the scope of the claims appended hereto. It will be apparent to those skilled in the art that modifications can be made in the embodiments chosen for illustration without departing from the spirit and scope of the invention.

What is claimed is:

1. A method of generating an electronic contact list comprising:
a) generating a profile of a user;
b) initiating a first live on-line chat session between the user and a first contact selected based on data within the profile;
c) ranking the first live on-line chat session as positive or negative; and
d) storing information from the first contact in the electronic contact list based on the ranking.

2. The method of claim 1, wherein the first live on-line chat session lasts for a predetermined period of time.

3. The method of claim 2, further comprising initiating a second live on-line chat session between the user and a second contact for the predetermined period of time.

4. The method of claim 1, wherein the on-line chat session is conducted using live video streaming.

5. The method of claim 1, wherein storing information from the first contact in the electronic contact list includes storing an electronic business card, when the ranking is positive.

6. The method of claim 1, further comprising providing product information between the user and the first contact when the ranking is positive.

7. A method of speed networking, the method comprising:
a) generating user profiles for users;
b) initiating one-on-one online chat sessions between a group of the users based on matched user profiles;
c) ranking the one-on-one online chat sessions according to a satisfaction factor to define sub-groups of compatible users; and
d) cataloging contact information between the compatible users.

8. The method of claim 7, wherein cataloging comprises automatically storing contact information between the compatible users in an electronic contact folder.

9. The method of claim 7, wherein the one-on-one online chat sessions last for predetermined period of time the method further comprising automatically initiating new one-on-one online chat sessions between a new users of the after the predetermined period of time has elapsed.

10. The method of claim 9, wherein the predetermined period of time is in a range of 1 to 15 minutes.

11. The method of claim 7, wherein the contact information includes an electronic coupon.

12. The method of claim 7, wherein cataloging contact information includes exchanging electronic business cards between the compatible users.

13. The method of claim 7, wherein the one-on-one online chat session includes live video steaming of the set of compatible users.

14. The method of claim 7, wherein the sub group of compatible users is defined by satisfaction rankings input by the users.

15. The method of claim 7, further comprising initiating further one-on-one online chat sessions between the users within the sub-group of compatible users.

16. An architecture for speed networking between users, the architecture comprising a server unit for generating and storing user profiles, the server unit further comprising applications software configured to automatically initiate one-on-one chat sessions for a predetermined period of time between a group of users logged into the server unit and that have matched user profiles.

17. The architecture of claim 16, wherein the applications software is configured to automatically exchange contact information between a sub-group of users from the group of users based on rankings of the one-on-one chat sessions by the group of users.

18. The architecture of claim 17, wherein the contact information includes an electronic business card, an electronic coupon or both.

19. The architecture of claim 17, wherein the server unit stores the contact information automatically exchanged between the sub-group of users in personalized contact libraries

20. The architecture of claim 17, wherein the applications software is further configured to automatically initiate one-on-one chat sessions for the predetermined period of time between a sub-group of users.

21. The architecture of claim 17, wherein the matched user profiles are determined by a common interest stored within the user profiles.
